(19) United States
(12) Patent Application Publication
(10) Pub. No.: US 2003/0172498 A1
(43) Pub. Date: Sep. 18, 2003

(54) Apparatus to cushion and dampen vibration and method

(76) Inventors: Bruce C. Polzin, Greendale, WI (US); Jeffrey E. Larson, Pell Lake, WI (US); Michael L. Kirst, Waukesha, WI (US); Gregory J. Uhlenhake, Burlington, WI (US)

Correspondence Address: FOLEY & LARDNER, 777 EAST WISCONSIN AVENUE, SUITE 3800, MILWAUKEE, WI, 53202-5308, US

(21) Appl. No.: 10/099,145

(22) Filed: Mar. 15, 2002

(51) Int. Cl. B62B 1/00

(52) U.S. Cl. 16/430

(57) ABSTRACT

An apparatus to cushion and dampen vibration and method for making such apparatus. The apparatus comprises a substrate member and an overmold disposed on the substrate member. The overmold is composed of a mixture of an elastrometric material and a foaming agent. The overmold comprises a first non-foam layer and a second non-foam layer, in conjunction, enveloping a micro-cellular foam layer.

### BACKGROUND OF THE INVENTION

The present invention relates generally to the field of vibration dampening and more particularly to an apparatus to cushion and dampen vibration with a micro-cellular foaming layer between two non-foaming layers.

Conventional methods for dampening vibration include the use of springs, weights and combinations of different materials. In the area of tools, particularly hand tools, a typical vibration dampening technique is to utilize a “soft” grip material attached or bonded to a hard or rigid substrate. Such tools typically are a hammer, screwdriver, grips on pliers but can also include a toothbrush. The substrate material can include low concentrations of foaming agents to prevent sink in a thicker molded part such as a solid paintbrush handle. Foaming agents have been used to foam the entire substrate and may be referred to as structural foam. Such techniques are used to reduce the amount of material in the molded parts. Another technique is the use of a “gas assist” molding process to create large air bubbles or voids in the center of a part to remove material, or increase cycle time or make the part lighter. An example of such a molded part is an interior automobile door handle.

The utilization of processes and products that have employed foaming or blowing agents with injection molding of tools or apparatus, examples such as mentioned above typically use non-elastomeric thermoplastic materials such as polypropylene, polyethelyne, nylon or filled thermal plastic materials such as glass filled nylon but not with thermoplastic elastomers.

In cases where thermal plastic elastomers have been utilized with foaming agents, it typically is for purposes of reducing the end product weight. For example, polyurethane can be extruded and/or cast with foaming agents to create a bun similar to a loaf of bread. In such case, the bubbles of the foaming agent are random in size and throughout the bun from the bottom to the top and left to right. An example of a product made from this process is the foam rubber used in chair cushions. Similarly, polyvinylchloride can be extruded with a foaming agent to create pipe insulation wraps. Such product is formed with bubbles randomly spaced throughout the end product. Such described processes do not utilize injection molding or control the size or location of the foaming agent used with the thermal plastic elastomers.

Desired characteristics of an apparatus to cushion and dampen vibrations would provide a hard thermoplastic elastomer material molded using an additive and processed to achieve a softer feel while retaining the physical properties of the harder material. The principal desirable characteristic is to have a microcellular “honeycombed” zone coupled to an apparatus such as a tool, which reacts similar to a gas filled shock absorber in that it compresses under pressure applied to the surface of the gripping area but rebounds after the pressure is released.

Thus, there is a need for an apparatus to cushion and dampen vibration transmitted through the apparatus to a user. There is a further need for an apparatus to cushion and dampen vibration that provides a surface hardness similar to that of a solid material but with an apparent softness in selected zones utilized for gripping or contacting the apparatus. There is additional need for a molded foam resin handle for a tool, particularly a hand held tool that will cushion and dampen vibrations transmitted through the tool to the user of such tool.

### SUMMARY OF THE INVENTION

The present invention provides an apparatus to cushion and dampen vibration. The apparatus comprises a substrate member and an overmold disposed on the substrate member. The overmold is composed of a mixture of an elastometric material and a foaming agent. The overmold comprises a first non-foam layer and a second non-foam layer, in conjunction, enveloping a microcellular foam layer.

There is also provided a tool comprising a tool-head and a grip coupled to the tool-head. The grip has a base with an overmold disposed on the grip. The overmold is composed of a mixture of an elastometric material and a foaming agent. The overmold comprises a first non-foam layer and a second non-foam layer, in conjunction, enveloping a microcellular foam layer.

There is also provided a molded foam resin handle for a tool. The molded foam resin handle comprises a base having a grip portion and a tool-head portion. An overmold is disposed on the grip portion of the base. The overmold is composed of a mixture of an elastometric material and a foaming agent. The overmold comprises a first non-foam layer and a second non-foam layer, in conjunction, enveloping a microcellular foam layer.

There is additionally provided a molded foam resin handle for a tool comprising a means for holding and a means for gripping. The means for holding has a grip portion and a tool head portion. The means for gripping is disposed on the grip portion of the means for holding. The means for gripping is composed of a mixture of an elastometric material and a foaming agent. The means for gripping comprises a first non-foam layer and a second non-foam layer, in conjunction, enveloping a microcellular foam layer.

There is further provided a method to make an apparatus by molding. The apparatus is to cushion and dampen vibration. The apparatus includes a substrate member and an overmold. The overmold is composed of a mixture of an elastometric material and a foaming agent. The overmold comprises a first non-foam layer and a second non-foam layer in conjunction, enveloping a microcellular foam layer. A method comprises the steps of providing the substrate member in a mold, then molding the overmold on the substrate member, wherein the apparatus is made. Removing the apparatus from the mold and controlling environmental conditions, to which the apparatus is subjected during one of a time the apparatus is in the mold and a time after the apparatus is removed from the mold.

### BRIEF DESCRIPTION OF THE DRAWINGS

FIG. 1 is a cross-sectional illustration of a prior art handle depicting a solid grip portion coupled to a base.

FIG. 2 is a cross-sectional illustration of an alternative embodiment of a prior art handle depicting a solid grip portion coupled to a base.

FIG. 3 is a perspective view of an exemplary embodiment of a molded foam resin handle for a tool.

FIG. 4 is a sectional view of the molded foam resin handle illustrated in FIG. 3 along the line 4-4.

FIG. 5 is a partial cross-sectional view of an exemplary embodiment of an apparatus to cushion and dampen vibration, with the overmold bonded to the substrate member.

FIG. 6 is a sectional view of the apparatus illustrated in FIG. 5 along the line 6-6.

FIG. 7 is a partial cross-sectional view of an exemplary embodiment of an apparatus to cushion and dampen vibration with the overmold mechanically attached to the substrate member.

FIG. 8 is a partial cross-sectional view of a handle for a tool illustrating the overmold configured in a predetermined shape.

### DETAILED DESCRIPTION OF THE EXEMPLARY EMBODIMENTS

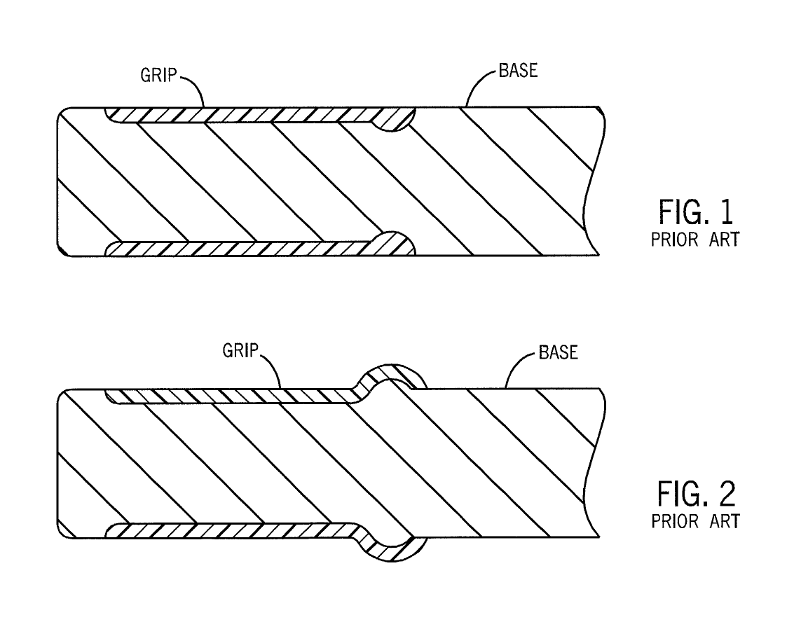

Referring to the figures, FIGS. 1 and 2 illustrate two embodiments of prior art handles. FIG. 1 illustrates a grip portion coupled to a base portion of a handle with a grip portion being a solid material. FIG. 2 also illustrates a prior art handle with a grip portion coupled to the base which the grip conforms to the shape of the base of the handle.

Prior art applications of a foaming agent with other materials such as polypropylene will not provide the characteristics sought in the present application. For instance, prior art applications, such as for audio speakers. In such application, the layers of rigid and foamed polypropylene are configured to enhance vibration. This is generally accomplished by having a high rigidity of the end product with a thin cross-section. In contrast, the present apparatus has characteristics of being flexible that dampens vibration. The present apparatus also utilizes elastomers to provide flexibility to facilitate structural variances and apparent softness techniques. As previously discussed, such prior art configurations do not provide the characteristics of a solid outer skin with an apparent softness that cushions and dampens vibration transmitted through the base of the apparatus.

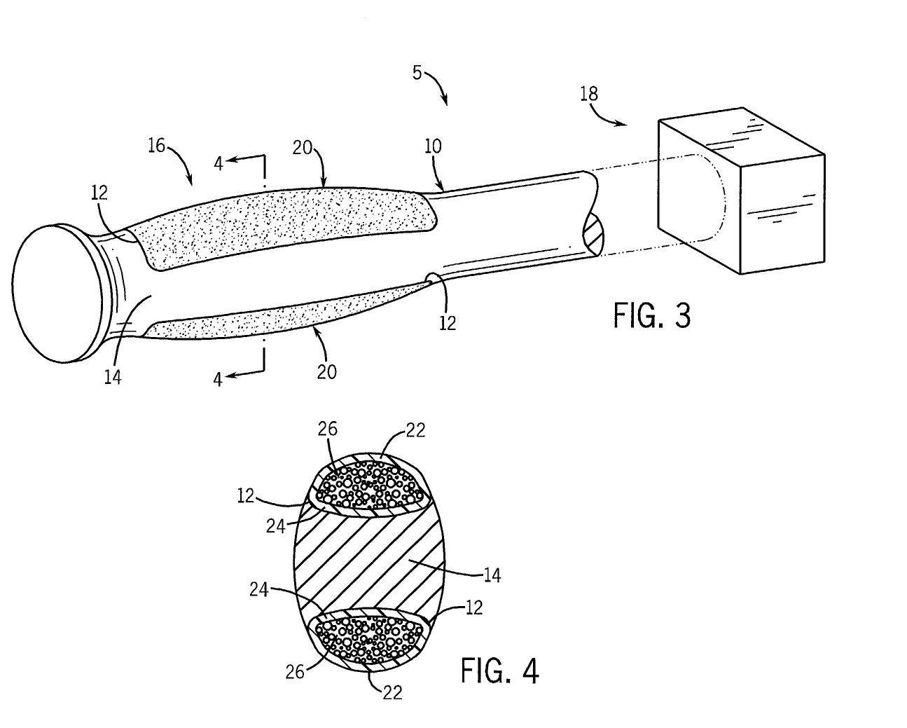

FIGS. 3-8 illustrate several exemplary embodiments of the present apparatus to cushion and dampen vibration comprising a substrate member 14 also referred to herein as a base, and an overmold 20 disposed on the substrate member 14. The overmold 20 is composed of a mixture of an elastometric material 21 and a foaming agent 23. The overmold 20 comprises a first non-foam layer 22 and a second non-foam layer 24, in conjunction, enveloping a microcellular foam layer 26. See particularly FIGS. 4-8. Inherent characteristics of the non-foam layers include tear resistance, solvent resistance, and tactile feel as compared to prior art solid, non-foamed elastomers.

The elastometric material 21 is a thermal plastic elastomer (TPE) that is selected from a group comprising thermal plastic olefins, thermalplastic rubbers, thermalplastic polyurethanes, polyvinylchlorides, styrenic block copolymers and can be combinations of one or more of such materials. The TPE plastic resin comes in pellet form that may require the removal of moisture from the resin if it becomes hydroscopic. The TPE material is used in standard injection molding machinery together with standard injection molding tooling. Because of the nature of the mixture of elastometric material 21 and the foaming agent 23 (as will be described hereinafter), a shut-off nozzle must be used with the injection molding machine to prevent the TPE material from drooling out of the nozzle tip between injection shots. Although injection molding is discussed and described herein, it is also contemplated that other types of molding techniques can be adapted to produce the apparatus described herein, for example, transfer molding techniques, or blow molding, or open pour-casting molding techniques can be utilized.

The particular type of elastometric material 21 that is to be selected by the designer of the apparatus or the operator of the molding process will depend on the particular application for which, the apparatus or tool 5 being manufactured will be utilized. For example, a polyurethane holds heat for a much longer time period than a polypropylene based TPE material. Such heat retention will affect the heat activated foaming agent and will require different controlling techniques as will be discussed hereinafter.

There are five primary factors that are needed to be controlled to produce an apparatus 5 that exhibits the desired characteristics as described above. Those factors include material selection, foaming agent 23 and elastometric material 21 concentration, thickness of the non-foam layer 22, 24 and the foam layer 26, temperature (temperature of the mixture, of the mold, and of ambient air) and the time at various stages during the manufacturing process.

The elastometric material 21 and the foaming agent 23 are typically mixed in the injection molding machine. Heaters in the injection molding machine heat the mixture to above the melting point of the components causing the foaming agent to mix with the thermoplastic elastomer. The elevated temperature activates the foaming agent 23 to start to expand, however, the mixture is constrained in the injection molding machine and is prevented from expanding further. It has been determined that a TPE material with greater heat retention affords a larger processing window during the manufacturing process.

The TPE material 21 can be advantageously compatible with the material used in the substrate member or base 14. The shape of the base 14 can vary, for example it can be elongated or asymmetrical.

The melted mixture of elastometric material 21 and the foaming agent 23 is injected into a mold cavity of a mold through a conventional injection mold runner system. The substrate member or base 14 may be already placed in the mold cavity by manual insertion or by molding it in place prior to injecting the melted mixture of elastometric material 21 and foaming agent 23 forming the overmold 20. The mixture is injected into the mold cavity and constrained within the mold cavity again inhibiting the foaming expansion of the foaming agent 23. When the mold cavity is filled, the shut-off nozzle closes stopping an injection of the mixture into the mold cavity.

Once the mixture of the elastometric material 21 and foaming agent 23 enters the mold cavity, the cooler temperature of the mold begins to act as a heat sink and lowers the temperature of the mixture at the interface between the mixture and the mold cavity. The hot mixture of elastometric material 21 and foaming agent 23 transfers heat to substrate member 14 and bonds together creating a bond between the overmold 20 and the substrate 14. The second non-foam layer 24 is formed at that interface (See FIGS. 4-8). The cooling of the mixture forming the overmold 20 on both sides of the form begins to form a skin or non-forming layer 22, 24 with virtually no expansion, thus creating a skin that is the same as a solid molded resin. As the skin cools, the lowering of the mixture temperature within the skin removes the activation temperature from the foaming agent 23 thereby stopping the expansion of the foaming agent 23 within the skin or non-foam layers, 22, 24. The interior portion of the overmold 20 which is where the microcellular foam layer 26 is located, continues to foam and expand but only to the point of filling the available space. At this juncture, various control techniques can be utilized by an operator of the injection molding system to make the apparatus desired. It is the controlling of the environmental conditions to which the apparatus is subjected during one of a time the apparatus is in the mold and a time after the apparatus is removed from the mold that will govern the final product.

After an appropriate time to be determined by an operator of the injection molding machinery, the apparatus 5 is removed from the mold. Removing the apparatus 5 from the mold also removes any confinement about the elastometric material 21 and continued expansion of the foaming agent 23 can take place. Such activity stretches the first and second non-foam layers, 22, 24 of the overmold 20 as the expansion force created by the foaming agent 23 pushes against the two layers. During this process, ambient air continues to act as a heat sink cooling down the outer surface of the skin. Ambient air around the apparatus 5 can be controlled which will affect the final product. As the overmold 20 continues to cool, it becomes less elastic and slows down the foaming agent 23 activity which in turn reduces the expansion forces exerted against the non-foam layers, 22, 24.

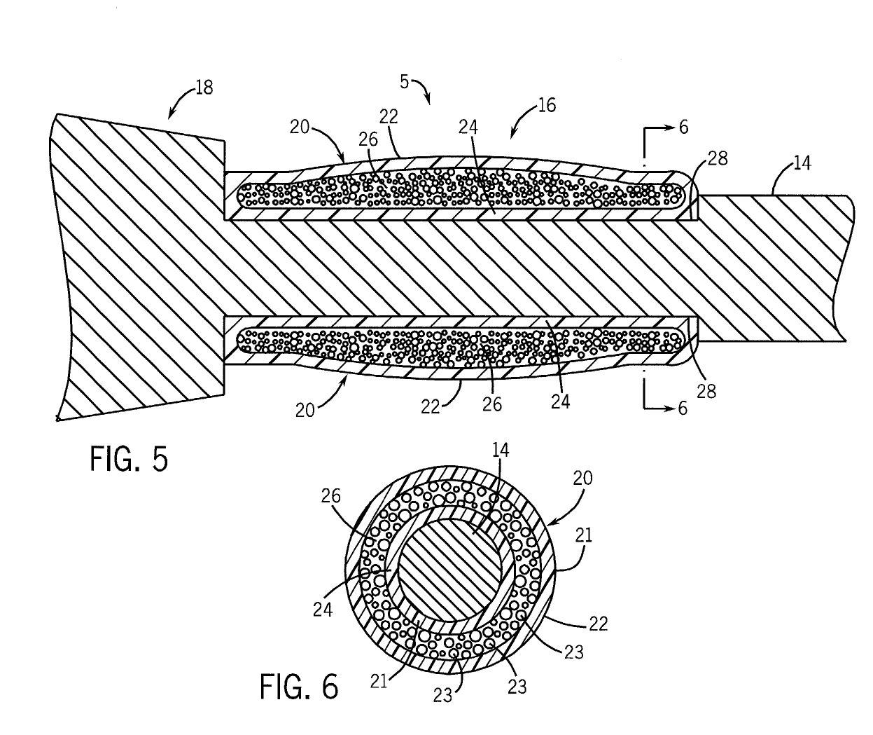

Additional factors that can be controlled during the process include controlling the temperature of the elastometric material 21 by various heating techniques such as heating coils or hot air flows. Also, the temperature of the mold can be controlled by various well known and convenient techniques to accelerate or inhibit the effect of the foaming agent 23. The thickness of the elastometric material 21 can be controlled by configuring the geometry of one of the substrate material 14 and the mold. An example of the changed geometry of the mold is shown in FIG. 5 and a change in the geometry of the substrate 14 on the overmold 20 is illustrated in FIG. 8.

The ratios between the foaming agent 23 and the elastometric material 21 is also an important control factor in the final overmold 20 structure and apparatus 5 configuration. The type of foaming agent needs to be matched with the type of TPE based material being used for the apparatus to insure compatability. The foaming agent 23 can be wet or dry, solid, liquid or gas. While various foaming agents may be used, it has been determined that to produce the appropriate micro-cellular foam layer 26, an endothermic foaming agent is used. The concentration of foaming agent 23 influences the effects of the microcells created in the foam layer 26. Typical concentrations of foaming agent 23 used with the elastometric material 21 range between 1.0-10.0 percent. To create selected pockets of foaming within the foam layer 26 of the overmold 20 a higher concentration of foaming agent 23 in the range of 2 to 8 percent or more is desirable. Applicants have determined that the use of Endex International's ABC27500® endothermic chemical foaming agent can be used for both the polyurethane and polypropylene based TPE elastometric material 21.

The thickness of the non-foam layers 22, 24 of the overmold 20 can influence the degree of micro-cellular bubbles created in the overmold 20 and the expansion of the non-foam layers 22, 24 as discussed above. The thicker the cross-section of the foamed TPE in he foam layer 26, the more the selected microcellular area of foaming will be, thus causing more expansion of the surface layers 22, 24 of the overmold 20. In some cases, the thickness of the foam layer 26 exceeds the combined thickness of the non-foam layers 22, 24. In another embodiment, the combined thickness of the non-foam layers 22, 24 exceeds the thickness of the foam layer 26. FIG. 5 illustrates the thickness of the foam area in different areas of the grip portion 16 of the base 14.

Controlling of the foaming agent, by the several processes described above, will affect the characteristics of the overmold 20. For example, too much expansion will create fewer but larger bubble cells and a larger expansion surface of the overmold 20. However, the honeycomb structure of the few large cells is not as strong as many smaller cells, with interlocking cell walls. If the foaming agent was allowed to expand to create a single bubble cell, it would not have any interlocking cell walls and would have very little internal strength.

To obtain the desired affect, the material thickness of the non-foam layers 22, 24 and the foam layer 26 must be selected and controlled with concentration of the foaming agent 23/and elastometric material 24, the temperatures of the mixture, the mold and of the ambient air and the time of reaction to achieve the desired affects for the overmold 20. Varying thicknesses of the layers within the same overmold 20 may be desired if the overmold 20 needs to have different zones of different degrees of cushioning. FIGS. 5, 7 and 8 illustrate several exemplary embodiments of varying thicknesses of the foam layer 26 within the overmold 20.

As mentioned above, temperature is a factor in influencing the degree of micro-cellular bubbles created in the foaming layer 26 and the expansion of the surface skin, the first and second non-foam layers 22, 24 of the overmold 20. The higher the melt temperature of the mixture of elastometric material 21 and foaming agent 23 the more heat the activated foaming agent 23 will create bubbles. These bubbles will increase in number and size with the increased heat. As the number and size of the cell bubbles increase, the expansion of the skimmed surface 22, 24 will increase creating an apparent softer material. The control of the temperature of the mixture can be controlled by varying the temperature of the mold using convenient and conventional methods or by controlling the ambient air in which the apparatus 5 is exposed upon removal from the mold.

Various time factors also influence the creation of the overmold 20 with the desired characteristics. The injection time to fill the cavity has some influence. The faster the melted mixture of elastometric material 21 and foaming agent 23 is injected into the mold cavity, the less heat loss will occur during filling. The time the apparatus 5 is kept in the mold die under hold pressure, the cooler die material will retard the creation of the micro-cellular air pockets in the foaming agent 23 because the colder mold continually withdraws the heat from the mixture. In addition to cooling the mixture, maintaining the mixture of elastometric material 21 and foaming agent 23 within the mold cavity prevents the expansion of the first and second non-foaming layers 22, 24 which impacts on the thickness of such layers. One effect of maintaining the apparatus 5 within the mold is that the compression affects of the injection force and the constraints of the mold overcome the force of the expanding foaming agent 23 and prevent the formation of micro-cellular voids within the foam layer 26 thereby providing a less soft effect. At such time as the apparatus 5 is removed from the mold, various procedures can be utilized to control the final shape of the overmold 20. For example, various restraining devices can be utilized such as a collar or a band pressing against the non-foam layers 22, 24 to retard the microcellular formation in that particular area.

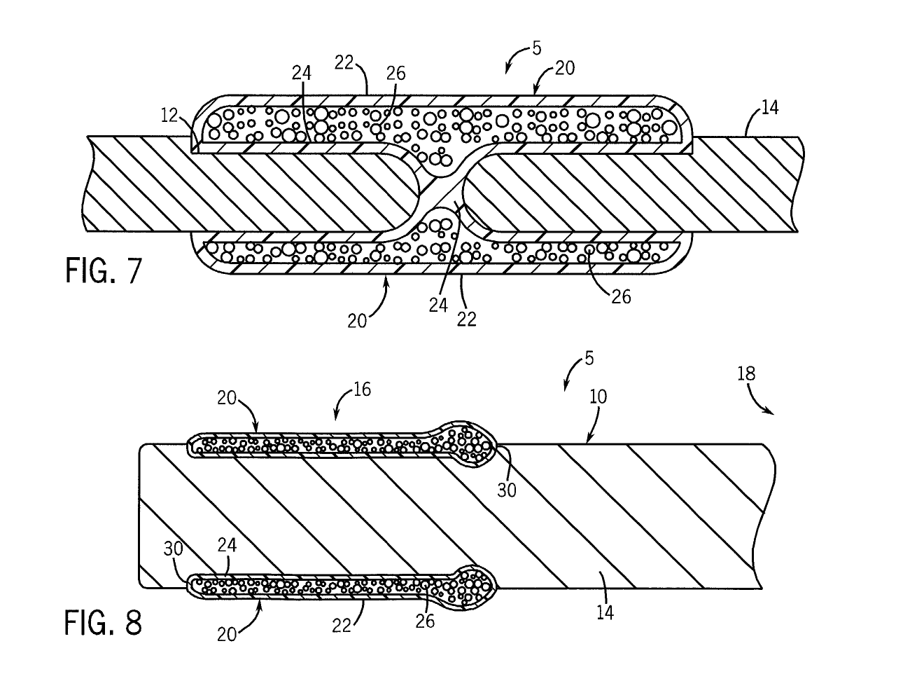

The overmold 20 can be attached to the substrate member or base 14 by mechanical means such as illustrated in FIGS. 5, 6 and 7. FIGS. 5 and 6 illustrate an encapsulation of the base 14 by the overmold 20. The apparatus or tools 5 where such encapsulation might be utilized can be for example at the end of a writing instrument or toothbrush. Another technique of mechanically attaching the two non-foam layers, 22, 24 and the foam layer 26 to the substrate member 14 is illustrated in FIG. 7 wherein an opening in the base 14 is filled by the second non-foaming layer 24 of the overmold 20 thereby securing the overmold 20 to the base 14. It is also contemplated that fasteners such as rivets, screws or the like can be utilized to attach an overmold 20 to a base 14. Pockets 12 formed in the base 14 can also be used to contain the overmold 20. The pockets can be longitudinal or radial or angled. Additional mechanical attachments can be utilized, such as for example nubs on the base 14 or holes in the base 14.

The overmold 20 can also be bonded to the substrate 14 as illustrated in FIG. 8. The bonding can occur at the molecular level between the elastometric material 21 of the overmold 20 and the substrate member 14 provided that the materials are chemically compatible. It is also contemplated that adhesives such as glue, epoxy or the like can be utilized to attach the overmold 20 to the substrate member 14.

The substrate member 14, also referred to as a base 14, can be selected from a group of materials, including wood, metal, thermoplastic resin, thermalset resin, epoxy, ceramic, glass and a combination of any two such materials. For example, a metal or fiberglass core surrounded by a thermoplastic resin can form the substrate member 14 upon which the overmold 20 is disposed during the manufacturing process. It is also contemplated that the substrate materials can be molded in the injection molding machine first and then the overmold 20 injection molded and disposed upon the substrate member 14.

The apparatus or tool 5 can also be configured to comprise a tool head 18 with a grip 16 coupled to the tool head 18. The grip 16 would include a base 14 with an overmold 20 disposed on the grip 16, with the overmold 20 composed of a mixture of an elastometric material 21 and a foaming agent 23 comprising a first non-foam layer 22 and a second non-foam layer 24 in conjunction, enveloping a microcellular foam layer 26. The tool head exemplary embodiment, illustrated in FIG. 3 can be the head of a hammer, the blade of a screwdriver, the motor and chuck of a drill, the blades of scissors or shears, the blade of a chisel and such other and suitable and convenient devices. It is also contemplated that the apparatus 5 having a substrate member 14 and an overmold 20 can be utilized as a bumper or a handle for a door such as in an automobile. With either or both, the substrate member 14 or the overmold 20 being configured to any suitable and convenient shape as determined by the molding process or by post-mold processes as described above can be utilized to configure the apparatus 5 to any suitable application.

Thus there is provided an apparatus with characteristics of a surface layer having an apparent softness and a shock absorber affect to cushion and dampen the vibrations transmitted through the apparatus. While the embodiments illustrated in the figures and described above are presently preferred, it should be understood that these embodiments are offered by way of example only. The invention is not intended to be limited to any particular embodiment but is intended to extend to various modifications that nevertheless fall within the scope of the appended claims. Other modifications will be evident to those with ordinary skill in the art.

What is claimed is:

1. An apparatus to cushion and dampen vibration, comprising:
a substrate member; and,
an overmold disposed on the substrate member, with the overmold composed of a mixture of an elastomeric material and a foaming agent, comprising a first non-foam layer and a second non-foam layer, in conjunction, enveloping a micro-cellular foam layer.

2. The apparatus of claim 1, wherein the elastomeric material is selected from a group comprising thermoplastic olefins, thermoplastic rubbers, thermoplastic polyurethanes, polyvinylchlorides, styrenic block copolymers, and combinations of such materials.

3. The apparatus of claim 1, wherein the substrate member is selected from a group of materials including: wood, metal, thermoplastic resin, thermoset resin, epoxy, ceramic, glass, and a combination of any two such materials.

4. The apparatus of claim 1, wherein the two non-foam layers and the foam layer are integrally molded with each other by injection molding of resin.

5. The apparatus of claim 1, wherein the two non-foam layers and the foam layer are mechanically attached to the substrate member.

6. The apparatus of claim 1, wherein the two non-foam layers and the foam layer are bonded to the substrate member.

7. The apparatus of claim 1, wherein the thickness of the foam layer exceeds the combined thickness of the non-foam layers.

8. The apparatus of claim 1, wherein the combined thickness of the non-foam layers exceeds the thickness of the foam layer.

9. The apparatus of claim 1, wherein the overmold is configured in a predetermined shape.

10. A tool comprising:
a tool-head;
a grip coupled to the tool-head, with the grip having a base; and,
an overmold disposed on the grip, with the overmold composed of a mixture of an elastomeric material and a foaming agent, comprising a first non-foam layer and a second non-foam layer, in conjunction, enveloping a micro-cellular foam layer.

11. The tool of claim 8, wherein the elastomeric material is selected from a group comprising thermoplastic olefins, thermoplastic rubbers, thermoplastic polyurethanes, polyvinylchlorides, styrenic block copolymers, and combinations of such materials.

12. The tool of claim 8, wherein the base is selected from a group of materials including: wood, metal, thermoplastic resin, thermoset resin, epoxy, ceramic, glass, and a combination of any two such materials.

13. The tool of claim 8, wherein the two non-foam layers and the foam layer are integrally molded with each other by injection molding of resin.

14. The tool of claim 8, wherein the two non-foam layers and the foam layer are mechanically attached to the base.

15. The tool of claim 8, wherein the two non-foam layers and the foam layer are bonded to the substrate member

16. The tool of claim 8, wherein the base has a plurality of pockets in the grip portion, wherein the overmold is contained.

17. The tool of claim 8, wherein the thickness of the foam layer exceeds the combined thickness of the non-foam layers.

18. The tool of claim 8, wherein the combined thickness of the non-foam layers exceeds the thickness of the foam layer.

19. The tool of claim 8, wherein the overmold is configured in a predetermined shape.

20. A molded foam resin handle for a tool, comprising:
a base having a grip portion and a tool-head portion; and,
an overmold disposed on the grip portion, with the overmold composed of a mixture of an elastomeric material and a foaming agent, comprising a first non-foam layer and a second non-foam layer, in conjunction, enveloping a micro-cellular foam layer.

21. The molded foam resin handle of claim 20, wherein the elastomeric material is selected from a group comprising thermoplastic olefins, thermoplastic rubbers, thermoplastic polyurethanes, polyvinylchlorides, styrenic block copolymers, and combinations of such materials.

22. The molded foam resin handle of claim 20, wherein the base is selected from a group of materials including: wood, metal, thermoplastic resin, thermoset resin, epoxy, ceramic, glass, and a combination of any two such materials.

23. The molded foam resin handle of claim 20, wherein the two non-foam layers and the foam layer are integrally molded with each other by injection molding of resin.

24. The molded foam resin handle of claim 20, wherein the two non-foam layers and the foam layer are mechanically attached to the base.

25. The molded foam resin handle of claim 20, wherein the two non-foam layers and the foam layer are bonded to the base.

26. The molded foam resin handle of claim 20, wherein the base has a plurality of pockets in the grip portion, wherein the overmold is contained.

27. The molded foam resin handle of claim 20, wherein the thickness of the foam layer exceeds the combined thickness of the non-foam layers.

28. The molded foam resin handle of claim 20, wherein the combined thickness of the non-foam layers exceeds the thickness of the foam layer.

29. The molded foam resin handle of claim 20, wherein the overmold is configured in a predetermined shape.

30. A molded foam resin handle for a tool, comprising:
a means for holding having a grip portion and a tool-head portion; and,
a means for gripping disposed on the grip portion, with the means for gripping composed of a mixture of an elastomeric material and a foaming agent, comprising a first non-foam layer and a second non-foam layer, in conjunction, enveloping a micro-cellular foam layer.

31. The molded foam resin handle of claim 30, wherein the elastomeric material is selected from a group comprising thermoplastic olefins, thermoplastic rubbers, thermoplastic polyurethanes, polyvinylchlorides, styrenic block copolymers, and combinations of such materials.

32. The molded foam resin handle of claim 30, wherein the two non-foam layers and the foam layer are integrally molded with each other by injection molding of resin.

33. The molded foam resin handle of claim 30, wherein the two non-foam layers and the foam layer are mechanically attached to the means for holding.

34. The molded foam resin handle of claim 30, wherein the two non-foam layers and the foam layer are bonded to the means for holding.

35. The molded foam resin handle of claim 30, wherein the means for holding has a plurality of means for containing in the grip portion, wherein the means for gripping is contained.

36. The molded foam resin handle of claim 30, wherein the thickness of the foam layer exceeds the combined thickness of the non-foam layers.

37. The molded foam resin handle of claim 30, wherein the combined thickness of the non-foam layers exceeds the thickness of the foam layer.

38. The molded foam resin handle of claim 30, wherein the means for gripping is configured in a predetermined shape.

39. A method to make an apparatus in a mold, the apparatus to cushion and dampen vibration, with the apparatus including a substrate member and an overmold composed of a mixture of an elastomeric material and a foaming agent, comprising a first non-foam layer and a second non-foam layer, in conjunction, enveloping a micro-cellular foam layer, the method comprising the steps of:
providing the substrate member in the mold;
molding the overmold on the substrate member, wherein the apparatus is made;
removing the apparatus from the mold; and,
controlling environmental conditions to which the apparatus is subjected during one of a time the apparatus is in the mold and a time after the apparatus is removed from the mold.

40. The method of claim 39, including the step of controlling the temperature of the elastomeric material.

41. The method of claim 39, including the step of controlling the mold temperature.

42. The method of claim 39, including the step of controlling the time the apparatus is in the mold.

43. The method of claim 39, including the step of controlling the thickness of the elastomeric material by configuring the geometry of one of the substrate material and mold.

44. The method of claim 39, including the step of controlling the ambient air temperature around the apparatus after removal from the mold.

45. The method of claim 39, including the step of mixing the elastomeric material and foaming agent in a predetermined ratio.

46. The method of claim 39, including the step of selectively restraining the overmold.
